(19) United States
(12) Patent Application Publication
(10) Pub. No.: US 2013/0143629 A1
(43) Pub. Date: Jun. 6, 2013

(54) Automatic Notification Setting Adjuster

(71) Applicant: Robert Richard Walling, III, Atlanta, GA (US)

(72) Inventor: Robert Richard Walling, III, Atlanta, GA (US)

(21) Appl. No.: 13/310,779

(22) Filed: Dec. 4, 2011

(51) Int. Cl. H04W 68/00; H04B 1/38

(52) U.S. Cl. 455/567

(57) ABSTRACT

A system, comprising a mobile communication device, receptive to receive a start time and an incoming communication notification intensity setting, and operable to adjust the incoming communication notification intensity to the received incoming communication notification intensity setting at the received start time. The mobile communication device, comprising an incoming communication notification, an incoming communication notification intensity, and an original incoming communication notification intensity setting.

### FIELD OF THE INVENTION

The invention relates generally to mobile communication devices and more specifically to incoming communication notifications.

### BACKGROUND OF THE INVENTION

In mobile communication devices, it is common to notify a user of an incoming communication or message with a notification. Often, the notification may be a noise, such as a ringtone. Frequently, a user is in a situation where it is inappropriate to have a device that could make noise. The user may forget to turn the notification noise off before entering such a situation. Another problem could be that the user did turn the notification noise off before entering such a situation, but later forgets to turn the notification noise back on and misses the notification for an incoming communication or message. Accordingly, what is needed in the art is a device that adjusts an incoming communication notification automatically.

### SUMMARY OF THE INVENTION

Disclosed herein is a system, comprising a mobile communication device, receptive to receive a start time and an incoming communication notification intensity setting, and operable to adjust the incoming communication notification intensity to the received incoming communication notification intensity setting at the received start time. The mobile communication device, comprising an incoming communication notification, an incoming communication notification intensity, and an original incoming communication notification intensity setting.

Disclosed herein is a method, comprising receiving a start time and an incoming communication notification intensity setting, and adjusting an incoming communication notification intensity to the received incoming communication notification intensity setting at the received start time.

Disclosed herein is a mobile communication device, comprising an incoming communication notification, an incoming communication notification intensity, an original incoming communication notification intensity setting, receiving a start time and an incoming communication notification intensity setting, and adjusting an incoming communication notification intensity to the received incoming communication notification intensity setting at the received start time.

The above described and other features are exemplified by the following figures and detailed description.

### BRIEF DESCRIPTION OF DRAWINGS

Referring now to the figures, which are exemplary embodiments, and wherein the like elements are numbered alike:

FIG. 1 is an exemplary embodiment of a user interface;

FIG. 2 is an exemplary embodiment of a user interface;

FIG. 3 is an exemplary embodiment of a user interface;

FIG. 4 is an exemplary embodiment of a monthly calendar;

FIG. 5 is an exemplary embodiment of a daily calendar;

FIG. 6 is an exemplary embodiment of a database table;

FIG. 7 is an exemplary embodiment of a database table;

FIG. 8 is an exemplary embodiment of a database table;

FIG. 9 is an exemplary embodiment of a database table;

FIG. 10 is an exemplary embodiment of a database table;

FIG. 11 is an exemplary embodiment of a database table;

FIG. 12 is an exemplary embodiment of a database table;

FIG. 13 is an exemplary embodiment of a flowchart;

FIG. 14 is an exemplary embodiment of a flowchart;

FIG. 15 is an exemplary embodiment of a flowchart; and

FIG. 16 is an exemplary embodiment of a flowchart.

### DETAILED DESCRIPTION

The present invention contains a system and/or a method that may be used in conjunction with a mobile communication device. A mobile communication device may be, for example, a Personal Digital Assistant (PDA), a cellular phone, a smart phone, or a computer, including a laptop computer or a tablet computer. A mobile communication device gives a notification in response to an incoming communication. The notification may be auditory, such as a ring, a beep, or a ringtone; visual, such as a text or a flashing screen; or tactile, such as a vibration. An incoming communication may be, for example, a call, a text message, an instant message, an e-mail, or a notification or an update from a social networking website.

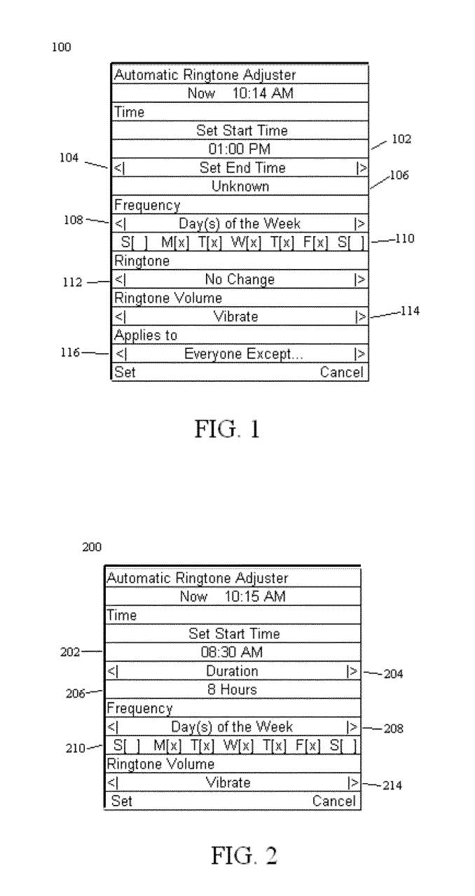

FIGS. 1-5 illustrate exemplary embodiments of ways of entering data into the system and/or the method that may be used in implementing the present invention. However, it will be obvious to one of ordinary skill in the art that numerous undisclosed user interfaces may be used to implement the present invention without departing from the essential scope thereof. Therefore, it is intended that the present invention not be limited to the particular embodiment disclosed, but that the present invention will include all embodiments falling within the scope of the appended claims.

Referring to FIG. 1, an exemplary embodiment of a user interface 100 that may be used in implementing the present invention. The user interface 100 may appear on a mobile communication device. A first field 102 may capture a time that a user wants one or more notification settings to change. Notification settings may include a notification intensity or a notification. A second field 104 may capture how the user wants to determine when the notification settings should change back to how the notification settings were before the system and/or the method made a change. For example, the second field 104 may be set to “Set End Time”, indicating that the user wants the end of the notification settings change entered as a time. Alternatively, the second field 104 may be set to “Duration”, indicating that the user wants the end of the notification settings change entered as an offset of the time entered in the first field 102. If the second field 104 is set to capture an end time, a third field 106 may capture the time that the notification settings should change back to what the notification settings were before the system and/or the method made the change. So if a user of a cellular phone has a meeting from 10:00 AM to 10:30 AM and wants the cellular phone's ringtone to automatically change to vibrate during the meeting and change back to normal afterwards, then the user may set the first field 102 to “10:00 AM”, the second field 104 to “Set End Time”, and the third field 106 to “10:30 AM”. If the second field 104 is set to capture an offset of the first field 102, the third field 106 may capture the duration of time that should pass before the notification settings change back to what the notification settings were before the system and/or the method made the change. So the cellular phone user mentioned above may prepare the cellular phone for the meeting by setting the first field 102 to “10:00 AM”, the second field 104 to “Duration”, and the third field 106 to “30 Minutes”. The second field 104 may have an option, such as “No End Time”, that indicates that the change to the notification settings that the system and/or the method made does not automatically change back. Alternatively, the third field 106 may have an option, such as “Unknown”, that indicates that the change to the notification settings that the system and/or the method made does not automatically change back. The cellular phone user may select “No End Time” for the second field 104 or “Unknown” for the third field 106 if the user thinks that the meeting might run over the scheduled end time.

A fourth field 108 may capture how often the notification settings should change. The fourth field 108 may be set to “Today”, “Tomorrow”, “Select Day(s)”, “Daily”, “Weekdays”, “Weekends”, “Monthly”, “Yearly”, “Select Day(s) of the Week”, “Holidays”, “Exempt Holidays”, etc. If the user sets the fourth field 108 to an option that requires further clarification, such as “Select Day(s)” or “Select Day (s) of the Week”, then a fifth field 110 may appear, which allows the user to select the specific day or days or the day or days of the week that the user would like the notification settings to automatically change. The cellular phone user mentioned above may set the fourth field 108 to “Today” if the meeting is today. If the meetings occurred every Tuesday and Friday, the cellular phone user may set the fourth field 108 to “Select Day(s) of the Week” and input “Tuesday” and “Friday” for the fifth field 110.

A sixth field 112 may capture what the notification should be. A seventh field 114 may capture how intense the notification should be; for example, how loud the ringtone rings, how bright the screen flashes, or how hard the communications device vibrates in response to an incoming communication. For example, the cellular phone user previously mentioned may want the cellular phone's ringtone to be inaudible. In such a circumstance, the user probably does not want to change the cellular phone's ringtone. The user may set the sixth field 112 to “No Change” and the seventh field 114 to “Silent” or “Vibrate”. Alternatively, the user may be waiting for a call, but may want to change the ringtone to a more professional sounding ringtone during the meeting and set the volume to the lowest audible setting. The user may set the sixth field 112 to the more professional ringtone and the seventh field 114 to “Low” or “1”.

An eighth field 116 may capture one or more sources, indicating from which sources the changes to the notification settings of an incoming message should apply. Possible options for the eighth field 116 include, for example, “Everyone”, “List . . . ”, and “Everyone Except . . . ”. For example, the cellular phone user previously mentioned may want the ringtone on the cellular phone set to “Vibrate” regardless of who is calling. The user may set the eighth field 116 to “Everyone”. Alternatively, the user may be a recent parent and may want the cellular phone to ring in the event that the babysitter is calling. The user may set the eighth field 116 to “Everyone Except . . . ”.

FIG. 2 illustrates another exemplary embodiment of a user interface 200 that may be used in implementing the present invention. The user interface 200 shown in FIG. 2 is similar to the user interface 100 shown in FIG. 1, but the user interface 200 shown in FIG. 2 is simpler. The user interface 200 does not have the sixth field 112 that allowed a user to change the notification or the eighth field 116, which allowed a user to associate changes to communication notifications with sources, such as specific people, numbers, contacts, etc. Therefore, the user interface 200 only allows a user to change the intensity of a notification but not the actual notification itself and any changes would apply to all incoming calls. A cellular phone user using an embodiment of the present invention that implemented the user interface 200 shown in FIG. 2 may cause the system and/or the method to automatically change the volume of the cellular phone's ringtone, but not which ringtone was actually played. And any changes made by the system and/or the method would apply to all the incoming calls regardless of the source. Incoming calls from the babysitter are not treated differently.

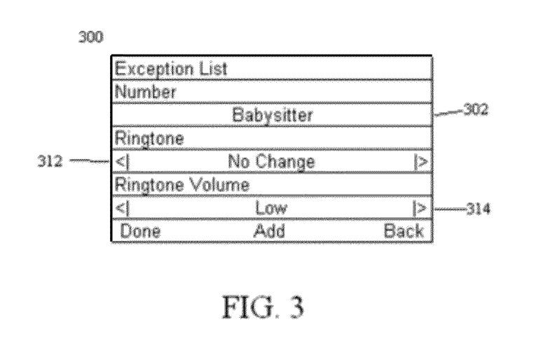

FIG. 3 illustrates another exemplary embodiment of a user interface 300 that may be used in implementing the present invention. When “List . . . ” or “Everyone Except . . . ” is entered into the eighth field 116 of the user interface 100 in FIG. 1, a list of which incoming communications should be included in or excluded from the notification setting changes may be created. The user interface 300 may contain a first field 302 that may capture a source for an incoming communication, such as a phone number, name from a contact list, e-mail address, instant message name, name, etc. A second field 312 may capture what the notification should be. A third field 314 may capture what the intensity of the notification should be. Taking the example of the cellular phone user from before, the user may want the phone to vibrate for calls from everyone except the babysitter. The user may want the phone to ring at a low volume if the babysitter calls. The user may have set the phone to vibrate during the meeting, and entered “Everyone Except . . . ” in the eighth field 116 of the user interface 100 in FIG. 1. The user interface 300 in FIG. 3 may appear to populate the list of callers whose calls should not go to vibrate. The user may select the babysitter's cellular phone from the user's contact list to fill the first field 302. Since the user does not want to change the ringtone that the cellular phone will play when the babysitter calls, the user may select “No Change” for the second field 312. And since the user wants the volume of the ringtone to be low, the user may enter “Low” in the third field 314.

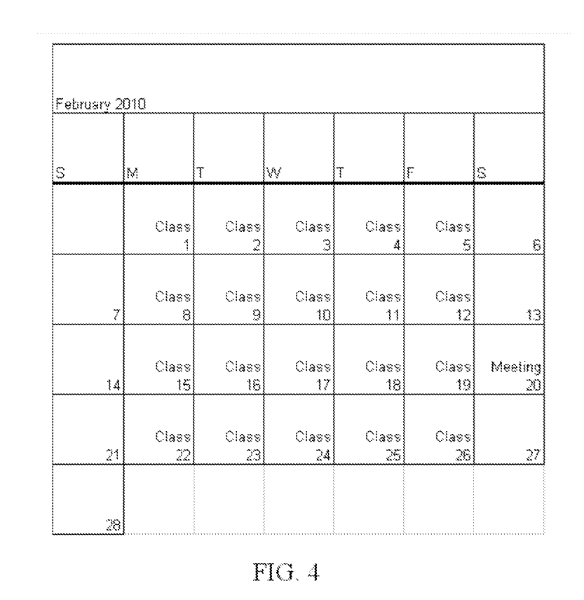

FIG. 4 illustrates an exemplary embodiment of a calendar 400. A user may import a calendar, planner, or schedule with one or more scheduled events. The system and/or the method may prompt the user as to whether notification setting changes should be associated with the scheduled events.

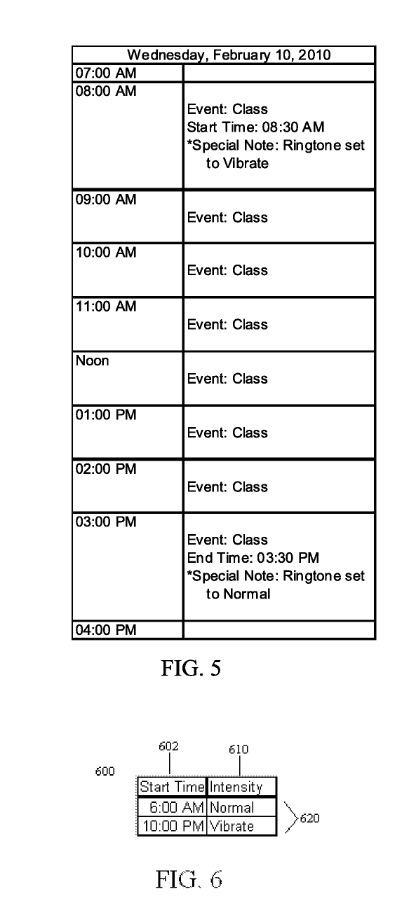

FIG. 5 illustrates an exemplary embodiment of a daily planner 500. A user may schedule one or more events in a calendar, planner, or schedule and may associate notification setting changes with events as the events are scheduled.

FIGS. 6-12 illustrate exemplary embodiments of ways of associating data that may be used in implementing the present invention. FIGS. 6-12 arrange the data in tables of databases, but the present invention may be implemented using any known way of organizing electronic data, such as, for example, linked lists, heaps, queues, search trees, etc. Several exemplary combinations of data fields are shown. However, it will be obvious to one of ordinary skill in the art that numerous undisclosed combinations of data fields may be used to implement the present invention without departing from the essential scope thereof. Therefore, it is intended that the present invention not be limited to the particular embodiment disclosed, but that the present invention will include all embodiments falling within the scope of the appended claims.

FIG. 6 illustrates an exemplary embodiment of a database table 600 that stores data for an implementation of the system and/or the method. The database table 600 may have a key field which indexes entries in the database table 600. The key field of the database table 600 is a “Start Time” field 602. An “Intensity” field 610 may store what intensity a notification of an incoming communication should be at a corresponding start time. In the case of a cellular phone, smart phone, or PDA, the notification of an incoming communication may be a ringtone and/or vibrations in response to an incoming call, text message, or e-mail message. An intensity may be a ringtone volume. When the system and/or the method is used with a smart phone, the database table 600 may have a “Ringtone Volume” field 610 as the “Intensity” field 610. A smart phone user may go to sleep everyday at 10:00 PM and wake up every morning at 6:00 AM. The user may want the phone's ringtone set to normal while the user is awake and set to vibrate while the user is asleep. Data 620 that populates the database table 600 instructs the system and/or the method to automatically change the ringtone volume of the smart phone to “Normal” at 6:00 AM and to “Vibrate” at 10:00 PM. Accordingly, the phone's ringtone volume automatically changes everyday at 6:00 AM and 10:00 PM while the data 620 populates the database table 600.

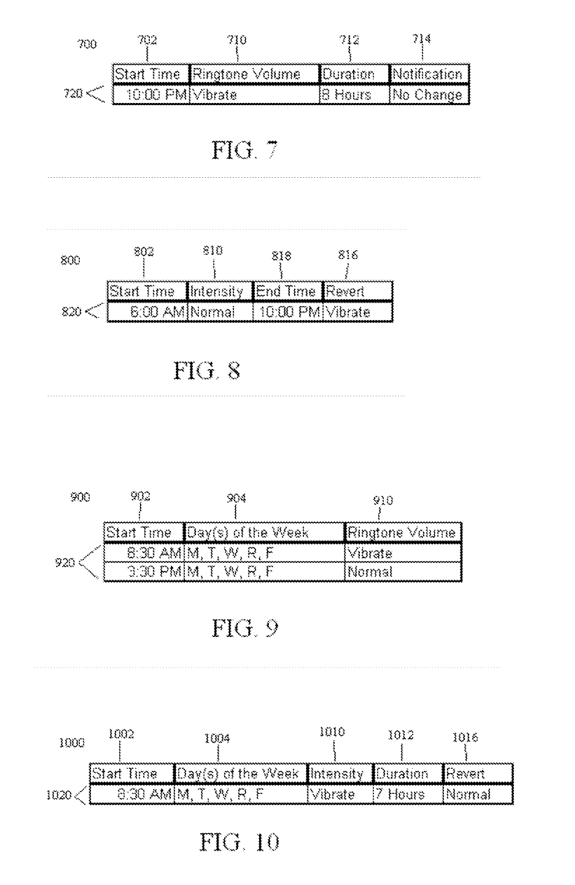

FIG. 7 illustrates another exemplary embodiment of a database table 700 that stores data for an implementation of the system and/or the method. The database table 700 may have a key field which indexes entries in the database table 700. The key field of the database table 700 is a “Start Time” field 702. An “Intensity” field 710 may store what intensity the notification of an incoming communication should be at a corresponding start time. A “Notification” field 714 indicates what a notification should be. A “Duration” field 712 indicates how long a change should last. After a time in the “Duration” field 712 has elapsed, a notification will change back to what the notification was before the change took place. When the system and/or the method is used with a smart phone, the database table 700 may have a “Ringtone Volume” field 710 as the “Intensity” field 710 and a “Ringtone” field 714 as the “Notification” field 714. A smart phone user may go to sleep everyday at 10:00 PM and wake up every morning at 6:00 AM. The user may want the phone's ringtone set to “Normal” while the user is awake and set to “Vibrate” while the user is asleep. Data 720 that populates the database table 700 instructs the system and/or the method to automatically change the ringtone volume of the smart phone to “Vibrate” at 10:00 PM and change the ringtone volume back to “Normal” eight hours later, at 6:00 AM. “No Change” in the “Ringtone” field 714 indicates that the ringtone will stay the same, even though the volume of the ringtone will not. Accordingly, the phone's ringtone volume automatically changes everyday at 6:00 AM and 10:00 PM while the data 720 populates the database table 700.

FIG. 8 illustrates another exemplary embodiment of a database table 800 that stores data for an implementation of the system and/or the method. The database table 800 may have a key field which indexes entries in the database table 800. The key field of the database table 800 is a “Start Time” field 802. An “Intensity” field 810 may store what intensity a notification of an incoming communication should be at a corresponding start time. The “End Time” field 818 contains the time that the change to the notification intensity should expire.

A “Revert” field 816 stores what the notification intensity should be when the change expires. A smart phone user may go to sleep everyday at 10:00 PM and wake up every morning at 6:00 AM. The user may want the phone's ringtone set to normal while the user is awake and set to vibrate while the user is asleep. Data 820 that populates the database table 800 instructs the system and/or the method to automatically change the ringtone volume of the smart phone to “Normal” at 6:00 AM and change it back to “Vibrate” at 10:00 PM. Accordingly, the phone's ringtone volume automatically changes everyday at 6:00 AM and 10:00 PM while the data 820 populates the database table 800.

FIG. 9 illustrates another exemplary embodiment of a database table 900 that stores data for an implementation of the system and/or the method. The database table 900 may have key fields which index entries in the database table 900. The key fields of the database table 900 are a “Start Time” field 902 and a “Day(s) of the Week” field 904. Together, the key fields indicate which days and times that the system and/or the method will make changes. An “Intensity” field 910 may store what intensity a notification of an incoming communication should be at a corresponding start time and one or more days of the week. A smart phone user may have class Monday through Friday from 8:30 AM until 3:30 PM. The smart phone user may want to set a ringtone volume on the smart phone to “Vibrate” while the user is in class and “Normal” otherwise. Data 920 that populates the database table 900 instructs the system and/or the method to automatically change the ringtone volume of the smart phone to “Vibrate” at 8:30 AM on Monday through Friday and change the ringtone volume to “Normal” at 3:30 PM on Monday through Friday. Accordingly, the system and/or the method automatically adjusts the phone's ringtone volume when the classes start and again when the classes end while the data 920 populates the database table 900.

FIG. 10 illustrates another exemplary embodiment of a database table 1000 that stores data for an implementation of the system and/or the method. The database table 1000 may have key fields which index entries in the database table 1000. The key fields of the database table 1000 are a “Start Time” field 1002 and a “Day(s) of the Week” field 1004. Together, the key fields indicate which days and times that the system and/or the method will make changes. An “Intensity” field 1010 may store what intensity a notification of an incoming communication should be at a corresponding start time and one or more days of the week. A “Duration” field 1012 indicates how long a change should last. After a time in the “Duration” field 1012 has elapsed, the notification intensity will change to what is in a “Revert” field 1016. A smart phone user may have class Monday through Friday from 8:30 AM until 3:30 PM. The smart phone user may want to set a ringtone volume on the smart phone to “Vibrate” while the user is in class and “Normal” otherwise. Data 1020 that populates the database table 1000 instructs the system and/or the method to automatically change the ringtone volume of the smart phone to “Vibrate” at 8:30 AM on Monday through Friday and change the ringtone volume to “Normal” 7 hours later at 3:30 PM. Accordingly, the system and/or the method automatically adjusts the phone's ringtone volume when the classes start and again when the classes end while the data 1020 populates the database table 1000.

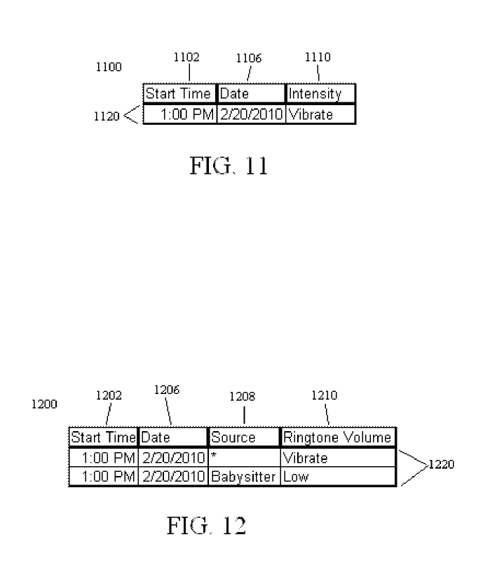

FIG. 11 illustrates another exemplary embodiment of a database table 1100 that stores data for an implementation of the system and/or the method. The database table 1100 may have key fields which index entries in the database table 1100. The key fields of the database table 1100 are a “Start Time” field 1102 and a “Date” field 1106. Together, the key fields indicate which date and time combinations the system and/or the method will make changes. An “Intensity” field 1110 may store what intensity a notification of an incoming communication should be at a corresponding start time and date. A smart phone user may have a meeting at 1:00 PM on Feb. 20, 2010 and may want the ringtone on the smart phone automatically set to “Vibrate” once the meeting starts. Data 1120 that populates the database table 1100 instructs the system and/or the method to automatically change the ringtone volume of the smart phone to “Vibrate” at 1:00 PM on Feb. 20, 2010. Accordingly, the system and/or the method automatically adjusts the phone's ringtone volume when the meeting starts.

FIG. 12 illustrates another exemplary embodiment of a database table 1200 that stores data for an implementation of the system and/or the method. The database table 1200 may have key fields which index entries in the database table 1200. The key fields of the database table 1200 are a “Start Time” field 1202, a “Date” field 1206, and a “Source” field 1208. Together, the key fields indicate which date and time combinations the system and/or the method will make changes and from which sources the changes will apply. An “Intensity” field 1210 may store what intensity a notification of an incoming communication should be from one or more sources at a corresponding start time and date. For a smart phone, the source may be a caller. A smart phone user may have a meeting at 1:00 PM on Feb. 20, 2010 and may want the smart phone to vibrate to indicate someone is calling, unless an incoming call is from the babysitter. If an incoming call is from the babysitter, the user may want the phone's ringtone to play at a low volume. Data 1220 that populates the database table 1200 instructs the system and/or the method to automatically change the volume of the phone's ringtone to “Vibrate” at 1:00 PM on Feb. 20, 2010, unless the incoming call is from the babysitter. If the incoming call is from the babysitter, then the system and/or the method allows the phone's ringtone to play at a “Low” volume. Accordingly, the system and/or the method automatically adjusts the phone's ringtone volume when the meeting starts.

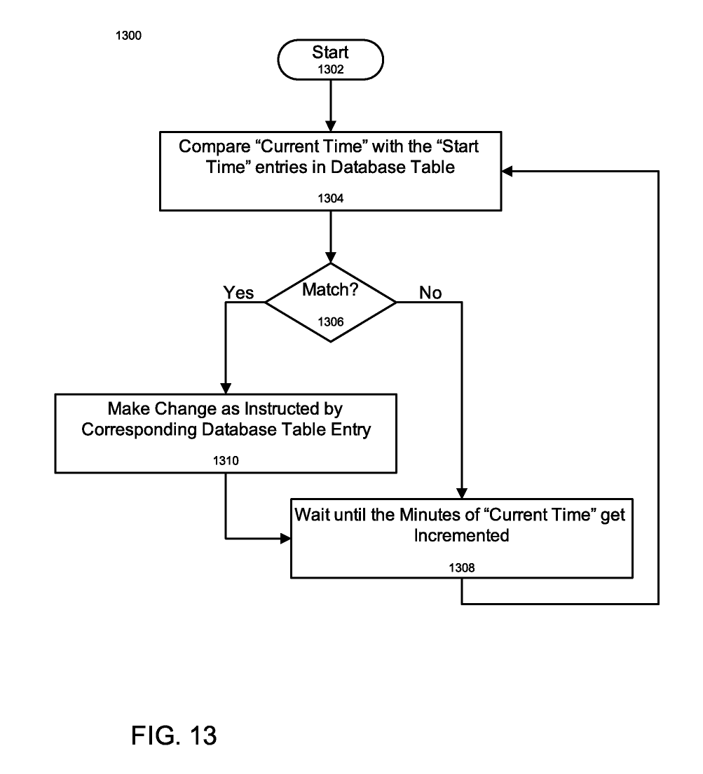

FIG. 13 illustrates an exemplary embodiment of a flow chart 1300 that implements the system and/or the method. A first block 1302 represents when the system and/or the method begins to run. In a second block 1304, a current time is compared against one or more entries in the system's and/or the method's database table 600, 700, 800. Next, a decision block 1306 determines if an entry exists with the current time as a key field 602, 702, 802. If no match exists, then the next step in the flow chart 1300 is a block 1308 where the system and/or the method waits until the minutes of the current time get incremented. If a match does exist, then the next step in the flow chart 1300 is a block 1310 where the system and/or the method makes one or more changes that are instructed by a corresponding database table entry. After the system and/or the method makes the changes, the next step is a block 1308 where the system and/or the method waits until the minutes of the current time get incremented. Once the minutes of the current time are incremented, the system and/or the method returns to the second block 1304.

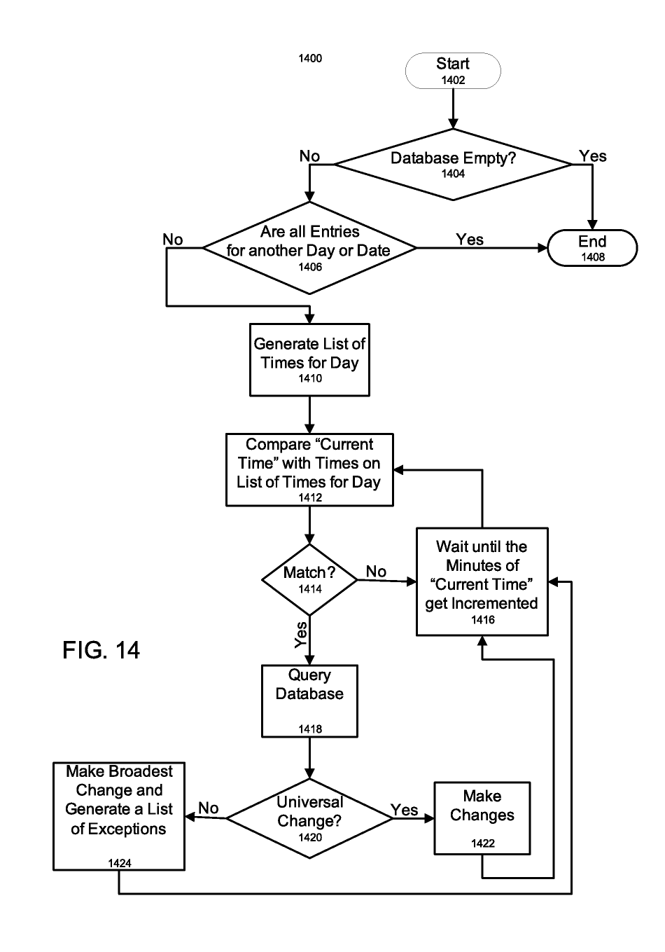

FIG. 14 illustrates another exemplary embodiment of a flow chart 1400 that implements the system and/or the method. The system and/or the method displayed in the flow chart 1400 is different from the previous flow chart 1300 because the flow chart 1400 does not have to query a database every minute and the flow chart 1400 allows the system and/or the method to make changes for individual sources. A first block 1402 represents when the system and/or the method begins to run. A next block 1404, which checks to see if the database is empty, runs at midnight every day. If the database is empty, then the next step in the flow chart 1400 is a block 1408 that exits the system and/or the method. If the database is not empty, the next step in the flow chart 1400 is a block 1406 that checks to see if any entries in a database table are to be applied today. If there are no entries for today, then the next block 1408 causes the system and/or the method to end. If there are entries in the database table that indicate that automatic changes apply today, then a next block 1410 generates a list of times for which changes need to be made for the day. A next block 1412 compares a current time with one or more times on a list. A next block 1414 determines if there is a match between the current time and the times on the list. If there is no match, a next block 1416 waits until the minutes of the current time get incremented. If there is a match, a next block 1418 will query the database and retrieve data necessary to implement the change. A next block 1420 checks to see if the change applies regardless of a source of an incoming communication. If the change does apply regardless of the source of the incoming communication, a next block 1422 makes the corresponding changes. After the changes are made, the next block 1416 waits until the minutes of the current time get incremented. If the change that applies is determined by the source of the incoming communication, a next block 1424, makes the broadest change and generates a list of the exceptions. The next block 1416 waits until the minutes of the current time get incremented.

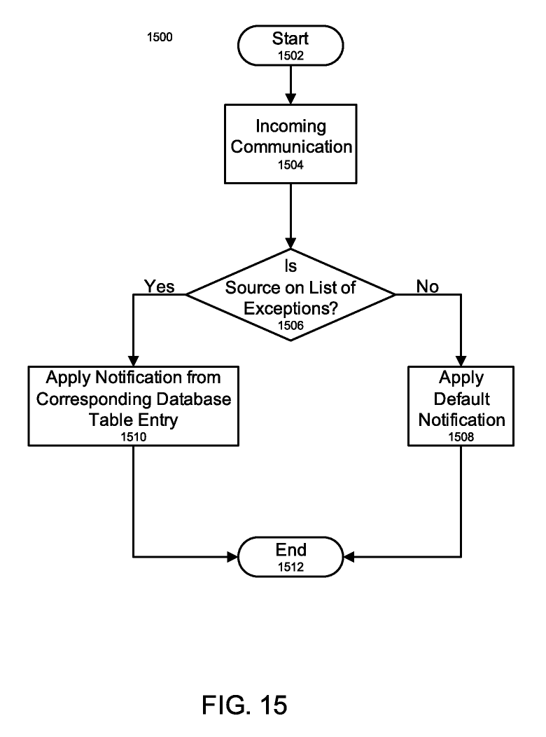

FIG. 15 illustrates another exemplary embodiment of a flow chart 1500 that implements the system and/or the method. The flow chart 1500 shows how the system and/or the method may handle an incoming communication when an incoming communication notification of a mobile communication device is dependent on a source of the incoming communication. A first block 1502 represents when the system and/or the method begins to run. A next block 1504 represents the incoming communication. In the example of a smart phone, the incoming communication may be an incoming call. A next block 1506 determines whether an incoming source is on an exception list. If the source is not on the exception list, then a next block 1508 on the flow chart 1500 initiates a default notification setting. For a smart phone, the phone may play a set ringtone at a set ringtone volume. If the source is on the list, then a next block 1510 on the flow chart 1500 applies a notification setting represented by a corresponding database table entry. For a smart phone, the incoming call may be from a babysitter, which appears on the exception list and causes the smart phone to play the set ringtone at a low volume, instead of a vibrate setting that the smart phone is currently set at. A final block 1512 indicates that the system and/or the method has successfully handled the incoming communication and issued a notification with the proper notification settings, regardless of the source.

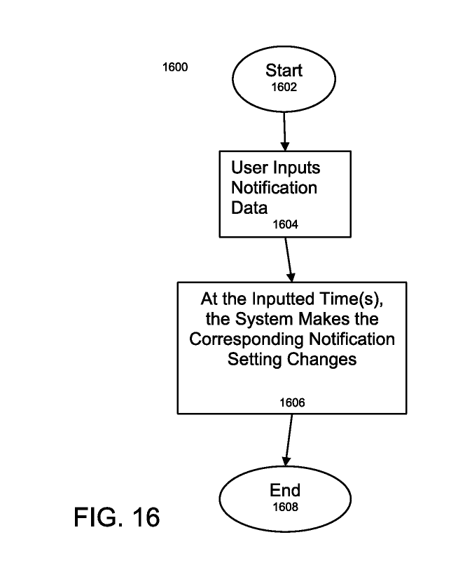

FIG. 16 illustrates another exemplary embodiment of a flow chart 1600 that implements the system and/or the method. A first block 1602 represents when the system and/or the method begins to run. A second block 1604 represents a user inputting one or more notification settings. A third block 1606 represents the system and/or the method making one or more instructed notification setting changes at one or more inputted times. A final block 1608 represents the end of the system and/or the method.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a mobile communication device with a computer system with a computer program that, when being loaded and executed, controls the computer system such that it carries out the methods described herein. Another typical combination may be a general-purpose computer system with a computer program that, when being loaded and executed, controls the computer system such that it carries out the methods described herein. Another typical combination may be both a mobile communication device with a computer system with a computer program that, when being loaded and executed, controls the computer system such that it carries out the methods described herein and a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claim is:

1. A system, comprising:
a mobile communication device, comprising:
an incoming communication notification;
an incoming communication notification intensity; and
an original incoming communication notification intensity setting;
receptive to receive a start time and an incoming communication notification intensity setting; and
operable to adjust the incoming communication notification intensity to the received incoming communication notification intensity setting at the received start time.

2. The system of claim 1, comprising:
the mobile communication device is a cellular phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

3. The system of claim 1, comprising:
the mobile communication device is a smart phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

4. The system of claim 1, comprising:
the mobile communication device is a personal digital assistant;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

5. The system of claim 1, comprising:
receptive to receive an end time; and
operative to adjust the incoming communication notification intensity to the original incoming communication notification intensity setting at the received end time.

6. The system of claim 5, comprising:
the mobile communication device is a cellular phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

7. The system of claim 5, comprising:
the mobile communication device is a smart phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

8. The system of claim 5, comprising:
the mobile communication device is a personal digital assistant;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

9. A method, comprising:
receiving a start time and an incoming communication notification intensity setting; and
adjusting an incoming communication notification intensity to the received incoming communication notification intensity setting at the received start time.

10. The method of claim 9, comprising:
the received incoming communication notification intensity setting is a ringtone volume setting.

11. The system of claim 9, comprising:
receiving an end time; and
adjusting the incoming communication notification intensity to an original incoming communication notification intensity setting at the received end time.

12. The system of claim 11, comprising:
the original incoming communication notification intensity setting is a ringtone volume setting; and
the received incoming communication notification intensity setting is a ringtone volume setting.

13. A mobile communication device, comprising:
an incoming communication notification;
an incoming communication notification intensity;
an original incoming communication notification intensity setting;
receiving a start time and an incoming communication notification intensity setting; and
adjusting an incoming communication notification intensity to the received incoming communication notification intensity setting at the received start time.

14. The mobile communication device of claim 13, comprising:
the mobile communication device is a cellular phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

15. The mobile communication device of claim 13, comprising:
the mobile communication device is a smart phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

16. The mobile communication device of claim 13, comprising:
the mobile communication device is a personal digital assistant;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

17. The mobile communication device of claim 13, comprising:
receiving an end time; and
adjusting the incoming communication notification intensity to the original incoming communication notification intensity setting at the received end time.

18. The mobile communication device of claim 17, comprising:
the mobile communication device is a cellular phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

19. The mobile communication device of claim 17, comprising:
the mobile communication device is a smart phone;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.

20. The mobile communication device of claim 17, comprising:
the mobile communication device is a personal digital assistant;
the incoming communication notification is a ringtone;
the incoming communication notification intensity is a ringtone volume;
the original incoming communication notification intensity setting is a ringtone volume setting; and
the received incoming communication notification intensity setting is a ringtone volume setting.
